(19) United States
(12) Patent Application Publication
(10) Pub. No.: US 2020/0209681 A1
(43) Pub. Date: Jul. 2, 2020

(54) REFLECTIVE DISPLAY PANEL AND MANUFACTURING METHOD THEREOF, AND DISPLAY DEVICE

(71) Applicant: BOE Technology Group Co., Ltd., Beiing (CN)

(72) Inventors: Yingtao Wang, Beijing (CN); Jikai Yao, Beijing (CN)

(21) Appl. No.: 15/752,283

(22) PCT Filed: Aug. 11, 2017
(86) PCT No.: PCT/CN2017/097005

§ 371 Date: Feb. 13, 2018

(30) Foreign Application Priority Data
Jan. 3, 2017 (CN) 201710002226.9

(51) Int. Cl. G02F 1/1335; G02F 1/13357; G02F 1/1362; G02F 1/1337

(52) U.S. Cl. CPC G02F 1/133553; G02F 1/133617; G02F 1/136227; G02F 2201/121; G02F 1/136209; G02F 2201/123; G02F 1/1337

(57) ABSTRACT

The present disclosure relates to a reflective display panel and a manufacturing method thereof and a display device in the field of display technology. The reflective display panel includes: a first substrate and a second substrate which are arranged opposite to each other, and a liquid crystal arranged between the first substrate and the second substrate. The first substrate includes a reflective layer and a photoluminescence layer, and the photoluminescence layer is arranged between the reflective layer and the liquid crystal.

### CROSS-REFERENCE TO RELATED APPLICATION

This application claims priority to Chinese Patent Application No.: 201710002226.9, filed with the State Intellectual Property Office on Jan. 3, 2017, the entire contents of which are incorporated herein by reference.

### TECHNICAL FIELD

The disclosure relates to the field of display technology, and in particular to a reflective display panel and a manufacturing method thereof, and a display device.

### BACKGROUND

With the development of display technologies, a variety of display panels have appeared, in which the reflective display panel can display an image without a backlight source.

### SUMMARY

In order to solve the problem of the poor display effect of the reflective display panel, embodiments of the present disclosure provide a reflective display panel and a manufacturing method thereof, and a display device. The technical solutions are as follows:

In a first aspect, there is provided a reflective display panel. The reflective display panel includes:

a first substrate and a second substrate which are arranged opposite to each other, and a liquid crystal arranged between the first substrate and the second substrate.

The first substrate comprises a reflective layer and a photoluminescence layer, and the photoluminescence layer is arranged between the reflective layer and the liquid crystal.

In some embodiments, the photoluminescence layer comprises a quantum dot layer which is configured to emit at least one color of excited light under the action of exciting light.

In some embodiments, the quantum dot layer comprises: red quantum dot blocks, green quantum dot blocks and transparent blocks.

The red quantum dot blocks are configured to emit red excited light under the action of blue exciting light, and the green quantum dot blocks are configured to emit green excited light under the action of blue exciting light.

In some embodiments, a first polarizer and a second polarizer are arranged at one side of the photoluminescence layer towards the second substrate in sequence in a direction away from the photoluminescence layer.

In some embodiments, the liquid crystal is a guest-host liquid crystal and serves as the first polarizer, and the second polarizer comprises a polaroid.

In some embodiments, the polaroid is arranged at one side of the second substrate away from the liquid crystal.

In some embodiments, the first polarizer comprises a first polarizing plate, and the second polarizer comprises a second polarizing plate.

In some embodiments, the first polarizing plate is arranged at one side of the first substrate towards the liquid crystal, and the second polarizing plate is arranged at one side of the second substrate away from the liquid crystal.

In some embodiments, the first substrate further comprises a first base substrate; a thin film transistor layer arranged on the first base substrate and comprising a plurality of thin film transistors which are arranged in an array;

an insulating layer arranged on the thin film transistor layer, where the reflective layer is arranged on the insulating layer, the photoluminescence layer is arranged on the reflective layer, the reflective layer is made of a conductor and comprises a plurality of reflective blocks which are arranged in an array, and the plurality of reflective blocks are in a one-to-one connection with drain electrodes in the plurality of thin film transistors through via holes in the insulating layer;

a flat layer arranged on the photoluminescence layer; and

a first alignment layer arranged on the flat layer.

In some embodiments, the first substrate further comprises a first base substrate, where the reflective layer is arranged on the first base substrate;

an insulating layer arranged on the reflective layer;

a thin film transistor layer arranged on the insulating layer, where the photoluminescence layer is arranged on the thin film transistor layer;

a pixel electrode layer arranged on the photoluminescence layer;

a flat layer arranged on the pixel electrode layer; and

a first alignment layer arranged on the flat layer.

In an embodiment, the second substrate comprises: a second base substrate; a black matrix and a flat layer arranged at one side of the second base substrate towards the liquid crystal and disposed in the same layer;

a common electrode layer arranged at one side of the black matrix and the flat layer towards the liquid crystal; and

a second alignment layer arranged at one side of the common electrode layer towards the liquid crystal.

In an embodiment, the reflective display panel further comprises a light source which is arranged at one side of the second substrate away from the liquid crystal and configured to generate exciting light that excites the photoluminescence layer.

In an embodiment, the light source comprises a light guide plate and a light-emitting device arranged at an end part of the light guide plate.

In a second aspect, there is provided a method for manufacturing a reflective display panel. The method includes:

forming a first substrate;

forming a second substrate; and

arranging a liquid crystal between the first substrate and the second substrate.

The first substrate comprises a reflective layer and a photoluminescence layer, and the photoluminescence layer is arranged between the reflective layer and the liquid crystal. The photoluminescence layer is configured to emit excited light under the action of exciting light.

In some embodiments, the photoluminescence layer comprises a quantum dot layer which is configured to emit at least one color of excited light under the action of exciting light.

In some embodiments, the quantum dot layer comprises red quantum dot blocks, green quantum dot blocks and transparent blocks.

The red quantum dot blocks are configured to emit red excited light under the action of blue exciting light, and the green quantum dot blocks are configured to emit green excited light under the action of blue exciting light.

In some embodiments, a first polarizer and a second polarizer are arranged at one side of the photoluminescence layer towards the second substrate in sequence in a direction away from the photoluminescence layer.

In some embodiments, the liquid crystal is a guest-host liquid crystal and serves as the first polarizer, and the second polarizer comprises a polaroid.

In a third aspect, there is provided a display device. The display device includes the reflective display panel described in the first aspect.

In some embodiments, the display device further comprises a light source which is configured to emit exciting light for exciting the photoluminescence layer to the second substrate of the display panel.

### BRIEF DESCRIPTION OF THE DRAWINGS

To describe the technical solutions in the embodiments of the present disclosure or in the prior art more clearly, the following briefly introduces the accompanying drawings required for describing the embodiments or the prior art. Apparently, the accompanying drawings in the following description show merely some embodiments of the present disclosure, and a person of ordinary skill in the art may still derive other drawings from these accompanying drawings without creative efforts.

FIG. 1 is a structural schematic diagram of a reflective display panel provided in an embodiment of the present disclosure;

FIG. 2 is a partial structural schematic diagram of a reflective display panel provided in an embodiment of the present disclosure;

FIG. 3 is a structural schematic diagram of another reflective display panel provided in an embodiment of the present disclosure;

FIG. 4 is a structural schematic diagram of yet another reflective display panel provided in an embodiment of the present disclosure;

FIG. 5A is a structural schematic diagram of a first substrate provided in an embodiment of the present disclosure;

FIG. 5B is a partial schematic diagram of a first substrate provided in an embodiment of the present disclosure;

FIG. 6A is a structural schematic diagram of another first substrate provided in an embodiment of the present disclosure;

FIG. 6B is a partial schematic diagram of another first substrate provided in an embodiment of the present disclosure;

FIG. 7 is a structural schematic diagram of a second substrate provided in an embodiment of the present disclosure;

FIG. 8 is a flow chart of a method for manufacturing a reflective display panel provided in an embodiment of the present disclosure;

FIG. 9 is a flow chart of a method for forming a first substrate provided in an embodiment of the present disclosure;

FIG. 10A is a partial structural schematic diagram of a first type of first substrate provided in an embodiment of the present disclosure;

FIG. 10B is a partial structural schematic diagram of a second type of first substrate provided in an embodiment of the present disclosure;

FIG. 10C is a partial structural schematic diagram of a third type of first substrate provided in an embodiment of the present disclosure;

FIG. 10D is a partial structural schematic diagram of a fourth type of first substrate provided in an embodiment of the present disclosure;

FIG. 10E is a partial structural schematic diagram of a fifth type of first substrate provided in an embodiment of the present disclosure;

FIG. 11 is a flow chart of a method for forming another first substrate provided in an embodiment of the present disclosure;

FIG. 12A is a partial structural schematic diagram of a sixth type of first substrate provided in an embodiment of the present disclosure;

FIG. 12B is a partial structural schematic diagram of a seventh type of first substrate provided in an embodiment of the present disclosure;

FIG. 12C is a partial structural schematic diagram of an eighth type of first substrate provided in an embodiment of the present disclosure;

FIG. 12D is a partial structural schematic diagram of a ninth type of first substrate provided in an embodiment of the present disclosure;

FIG. 12E is a partial structural schematic diagram of a tenth type of first substrate provided in an embodiment of the present disclosure;

FIG. 12F is a partial structural schematic diagram of an eleventh type of first substrate provided in an embodiment of the present disclosure;

FIG. 13 is a flow chart of a method for forming a second substrate provided in an embodiment of the present disclosure;

FIG. 14A is a partial structural schematic diagram of a first type of second substrate provided in an embodiment of the present disclosure;

FIG. 14B is a partial structural schematic diagram of a second type of second substrate provided in an embodiment of the present disclosure;

FIG. 14C is a partial structural schematic diagram of a third type of second substrate provided in an embodiment of the present disclosure;

FIG. 15 is a structural schematic diagram of a display device provided in an embodiment of the present disclosure;

FIG. 16A is a schematic diagram of a reflective display panel provided in an embodiment of the present disclosure; and

FIG. 16B is a schematic diagram of a reflective display panel provided in an embodiment of the present disclosure.

### DETAILED DESCRIPTION OF THE EMBODIMENTS

The present disclosure will be described in further detail with reference to the enclosed drawings, to clearly present the objects, technique solutions, and advantages of the present disclosure.

When introducing elements and embodiments of the disclosure, the singular forms of the words as used herein and in the appended claims include plural referents unless the context clearly dictates otherwise, vice versa. Thus, when referring to a singular, it generally includes the plural of the corresponding term. Words “include(s)”,“comprise(s)”, “contain(s)” and “having” are intended to be inclusive and mean that there may be additional elements other than the listed elements.

For the purpose of the following superficial description, as it is scaled in the drawings, the terms “upper”, “lower”, “left”, “right”, “vertical”, “horizontal”, “top”, “bottom” and their derivatives should relate to the disclosure text. The terms “overlying,” “on the top of”, “positioned on” or “positioned on the top of” mean that a first element, such as a first structure is present on a second element, such as a second structure, wherein an intermediate element, such as an interfacial structure may be present between the first element and the second element. The term “contact” means connecting a first element, such as a first structure, and a second element, such as a second structure, with or without other elements at the interface of the two elements.

A reflective display panel may comprise a first substrate and a second substrate which are arranged opposite to each other, and a liquid crystal arranged between the first substrate and the second substrate. The first substrate may comprises a first base substrate and a thin film transistor layer arranged on the first base substrate. A pixel electrode layer may be arranged on the thin film transistor layer and can reflect light. The second substrate comprises a second base substrate, and a color resistant layer and a common electrode layer which are sequentially arranged on the second base substrate. The color resistant layer may comprise red color resistant blocks, green color resistant blocks and blue color resistant blocks. Ambient light can pass through the color resistant layer and the liquid crystal in sequence from one side of the second substrate away from the first substrate and reaches the pixel electrode layer on the first substrate. The ambient light is then reflected by the pixel electrode layer, passes through the liquid crystal and the color resistant layer again and is finally emitted out from the second substrate. It should be noted that red light in the ambient light can pass through the red color resistant blocks, green light in the ambient light can pass through the green color resistant blocks, and blue light in the ambient light can pass through the blue color resistant blocks. When the display panel needs to be controlled to display an image, the luminous flux of regions corresponding to the color resistant blocks on the display panel can be adjusted by controlling a deflection angle of the liquid crystal corresponding to each color resistant block, such that the display panel displays the image.

Since each color resistant block allows light within a large frequency range to pass through and the region corresponding to each color resistant block on the reflective display panel can emit various colors of light, the light emitted from the region corresponding to each color resistant block on the reflective display panel has low purity, and therefore the display effect of the reflective display panel is poor.

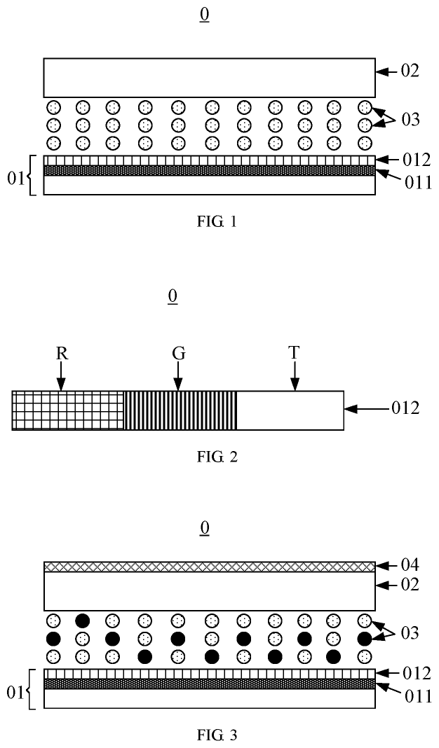

As shown in FIG. 1, an embodiment of the disclosure provides a reflective display panel 0. The reflective display panel 0 may comprise: a first substrate 01 and a second substrate 02 which are arranged opposite to each other, and a liquid crystal 03 arranged between the first substrate 01 and the second substrate 02. The first substrate 01 comprises a reflective layer 011 and a photoluminescence layer 012, and the photoluminescence layer 012 is arranged between the reflective layer 011 and the liquid crystal 02. The photoluminescence layer 03 can emit excited light under the action of exciting light.

From the above, since the first substrate in the reflective display panel provided by the embodiment of the disclosure comprises a reflective layer and a photoluminescence layer, the photoluminescence layer in the first substrate can emit excited light under the action of exciting light and the excited light has a small frequency range, the purity of light emitted from each region on the display panel is improved, and therefore the display effect of the display panel is improved.

According to an embodiment of the disclosure, the photoluminescence layer 012 may comprise a quantum dot layer which may emit at least one color of excited light under the action of exciting light. The first substrate 01 or the second substrate 02 is an array substrate.

FIG. 2 is a partial structural schematic diagram of a reflective display panel 0 provided by an embodiment of the disclosure. As shown in FIG. 2, when the photoluminescence layer 012 comprises a quantum dot layer, the quantum dot layer may comprise: red quantum dot blocks R, green quantum dot blocks G and transparent blocks T. The red quantum dot blocks R emit red excited light under the action of blue exciting light, and the green quantum dot blocks G emit green excited light under the action of blue exciting light.

That is, when the blue exciting light irradiates on the quantum dot layer, the red quantum dot blocks R can emit red excited light and the green quantum dot blocks G can emit green excited light. Blue exciting light can pass through the transparent blocks T, reaches the reflective layer 011, is finally reflected by the reflective layer 011 to the transparent blocks T, and is further emitted out from the transparent blocks T, such that the region where the transparent blocks T are located on the reflective display panel can emit blue light, and further various regions on the reflective display panel 0 can emit red light, green light and blue light respectively, and therefore, the reflective display panel 0 can display a color image.

It should be noted that a first polarizer and a second polarizer may be arranged at one side of the photoluminescence layer towards the second substrate in sequence in a direction away from the photoluminescence layer. Exemplarily, the two polarizers may be arranged in the following two manners.

In the first manner, FIG. 3 is a structural schematic diagram of another reflective display panel 0 provided by an embodiment of the disclosure. As shown in FIG. 3, the liquid crystal 03 may be a guest-host liquid crystal. One of the polarizers in the reflective display panel is a guest-host liquid crystal and the other is a polaroid 04. In other words, in the present embodiment, the guest-host liquid crystal serves as the first polarizer, and the second polarizer comprises a polaroid. Exemplarily, the polaroid 04 may be arranged at one side of the second substrate 02 away from the liquid crystal 03. Here, the reflective display panel 0 only comprises one polaroid, and the polaroid is positioned outside a liquid crystal box formed by the first substrate and the second substrate.

When the reflective display panel is used, the light output amount of the reflective display panel may be controlled by adjusting the projection of a long axis of a guest-host liquid crystal molecule in the direction of the light transmission axis of the polaroid. The larger of the projection of the long axis of the liquid crystal molecule in the direction of the light transmission axis of the polaroid, the less the light output amount of the reflective display panel. The smaller of the projection of the long axis of the liquid crystal molecule in the direction of the light transmission axis of the polaroid, the larger the light output amount of the reflective display panel.

When the long axis of the guest-host liquid crystal is parallel to the light transmission axis of the polaroid 04, the projection of the long axis of the guest-host liquid crystal in the direction of the transmission axis of the polaroid is the largest. Exciting light (natural light) which is emitted to the reflective display panel 0 from one side of the polaroid 04 away from the second substrate 02 can pass through the polaroid 04, and the polarization direction of the exciting light that passes through the polaroid 04 is a first direction (polarized light). When the exciting light that passes through the polaroid 04 reaches the liquid crystal 03 (i.e., the guest-host liquid crystal), since the long axis of the liquid crystal 03 is parallel to the light transmission axis of the polaroid 04, the guest-host liquid crystal can completely absorb the exciting light whose polarization direction is the first direction. Therefore, the exciting light which reaches the guest-host liquid crystal cannot pass through the guest-host liquid crystal, and the photoluminescence layer cannot be excited, such that the reflective display panel presents a dark state.

When a voltage is applied to the guest-host liquid crystal such that the long axis of the guest-host liquid crystal is vertical to the light transmission axis of the polaroid, the projection of the long axis of the guest-host liquid crystal in the direction of the light transmission axis of the polaroid is the smallest. The guest-host liquid crystal cannot absorb the exciting light that passes through the polaroid, and therefore the exciting light that passes through the polaroid 04 can pass through the guest-host liquid crystal and reach the photoluminescence layer, such that the photoluminescence layer is excited to emit the excited light. In addition, the excited light may also pass through the guest-host liquid crystal and the polaroid, and consequently, the reflective display panel presents a bright state.

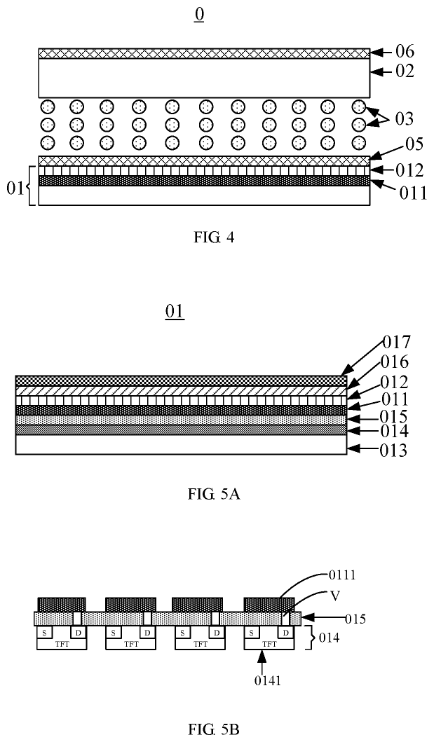

In the second manner, FIG. 4 is a structural schematic diagram of yet another reflective display panel provided by an embodiment of the disclosure. As shown in FIG. 4, the liquid crystal 03 in the reflective display panel 0 is not a guest-host liquid crystal. Here, the first polarizer in the reflective display panel 0 comprises a first polaroid 05, and the second polarizer comprises a second polaroid 06. The first polaroid 05 may be arranged between the photoluminescence layer 012 and the liquid crystal 03 (i.e., arranged at one side of the first substrate towards the liquid crystal). The second polaroid 06 may be arranged at one side of the second substrate 02 away from the first substrate 01, and the light transmission axis of the first polaroid 05 is vertical to the transmission axis of the second polaroid 06.

In some embodiments, the first substrate in the embodiment of the present disclosure may be an array substrate, and the second substrate may also be an array substrate. It is assumed that the first substrate is an array substrate, then the first substrate may have a plurality of specific structures. Two of the implementation ways therein are illustrated now.

On the one hand, FIG. 5A is a structural schematic diagram of a first substrate 01 provided by an embodiment of the present disclosure. As shown in FIG. 5A, the first substrate 01 may comprise: a first base substrate 013, a thin film transistor layer 014, an insulating layer 015 and a reflective layer 011, where the thin film transistor layer 014 is arranged on the first base substrate 013 and may comprise a plurality of thin film transistors which are arranged in an array. Each thin film transistor may comprise a gate electrode, a source electrode and a drain electrode. The insulating layer 015 is arranged on the thin film transistor layer 014. The reflective layer 011 is arranged on the insulating layer 015 and made of a conductor (such as, aluminum). The reflective layer 011 may comprise a plurality of reflective blocks which are arranged in an array and in a one-to-one connection with the drain electrodes in the plurality of thin film transistors through a plurality of via holes (not shown in FIG. 5A) in the insulating layer 015, that is, the reflective layer 011 in FIG. 5A also plays a role of a pixel electrode at the same time. The first substrate further comprises a photoluminescence layer 012 arranged on the reflective layer 011, a flat layer 016 arranged on the photoluminescence layer 012 and a first alignment layer 017 arranged on the flat layer 016. In some embodiments, the flat layer 016 may be made of the same material as that of transparent blocks in the photoluminescence layer 012.

FIG. 5B is a partial schematic diagram of a first substrate according to an embodiment of the present disclosure. As shown in FIG. 5B, the reflective layer 011 may comprise a plurality of reflective blocks 0111 which are arranged in an array, and the plurality of reflective blocks are in a one-to-one connection with the drain electrodes D in the plurality of thin film transistors via a plurality of via holes V in the insulating layer 015, that is, the reflective layer 011 in FIG. 5A also plays a role of a pixel electrode at the same time.

In the first substrate as shown in FIG. 5A, since the reflective layer can play a role of the pixel electrode and the reflective layer at the same time, no pixel electrode needs to be arranged additionally in the first substrate. Therefore, the thickness of the first substrate is reduced, and further the thickness of the reflective display panel is reduced.

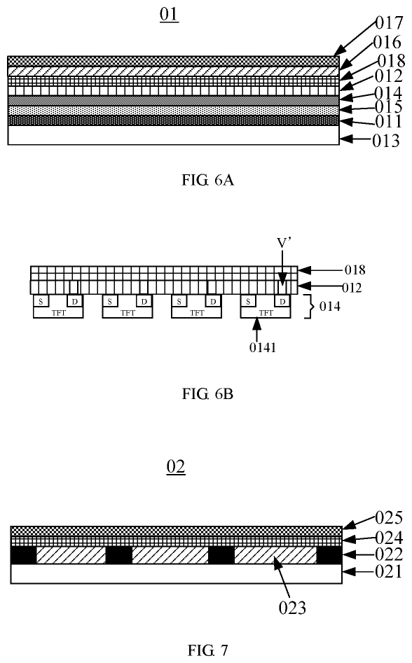

On the other hand, FIG. 6A is a structural schematic diagram of another first substrate 01 provided by an embodiment of the disclosure. As shown in FIG. 6A, the first substrate 01 may comprise: a first base substrate 013, a reflective layer 011, an insulating layer 015, a thin film transistor layer 014, a photoluminescence layer 012, a pixel electrode layer 018, a flat layer 016 and a first alignment layer 017, where the reflective layer 011 (the reflective layer may be made of aluminum) is arranged on the first base substrate 011. The insulating layer 015 is arranged on the reflective layer 011. The thin film transistor 014 is arranged on the insulating layer 015. The photoluminescence layer 012 is arranged on the thin film transistor layer 014. The pixel electrode layer 018 is arranged on the photoluminescence layer 012 and is connected with the drain electrodes in the thin film transistor layer 014 through via holes in the photoluminescence layer 012. The flat layer 016 is arranged on the pixel electrode layer 018. The first alignment layer 017 is arranged on the flat layer 016.

FIG. 6B a partial schematic diagram of a first substrate according to an embodiment of the disclosure. As shown in FIG. 6B, the pixel electrode layer 018 is connected with the drain electrode in the thin film transistor layer 014 through via holes in the photoluminescence layer 012.

FIG. 7 is a structural schematic diagram of a second substrate 02 provided by an embodiment of the disclosure. As shown in FIG. 7, the second substrate 02 comprises a second base substrate 021, a common electrode layer 024 and a second alignment layer 025, where a black matrix (BM) 022 and a flat layer 023 are arranged at one side of the second base substrate 021 towards the liquid crystal 03 and are located in the same layer. The common electrode layer 024 is arranged on the black matrix 022 and the flat layer 023. The second alignment layer 025 is arranged on the common electrode layer 024. The black matrix in the second substrate can play a shielding effect on the thin film transistor structure on the first substrate, thereby further improving the display effect of the reflective display panel.

It should be noted that both the first substrate 01 as shown in FIG. 5A and the first substrate 01 as shown in FIG. 6A may be combined with the second substrate 02 as shown in FIG. 7, which will not be defined in the embodiment of the disclosure. After the first substrate and the second substrate are arranged opposite to each other, the first alignment layer on the first substrate is arranged close to the second substrate, and the second alignment layer on the second substrate is arranged close to the first substrate.

Further, when the second substrate is an array substrate, the first substrate may comprise: a first base substrate, a reflective layer arranged on the first base substrate (the reflective layer may be made of aluminum), a photoluminescence layer arranged on the reflective layer, a flat layer arranged on the photoluminescence layer, a common electrode layer arranged on the flat layer, and a first alignment layer arranged on the common electrode layer.

The second substrate may comprise a second base substrate, a thin film transistor layer, an insulating layer, a pixel electrode layer and a second alignment layer, where a black matrix and a flat layer are arranged at one side of the second base substrate towards the liquid crystal and are located in the same layer. The thin film transistor layer is arranged on the black matrix and the flat layer. The insulating layer is arranged on the thin film transistor layer. The pixel electrode layer is arranged on the insulating layer and is connected with the drain electrodes in the thin film transistor layer through via holes in the insulating layer. The second alignment layer is arranged on the pixel electrode layer.

It should be noted that the thin film transistor layer may be made of a transparent material when the second base substrate is an array substrate.

FIG. 16A is a schematic diagram of a reflective display panel according to an embodiment of the disclosure. As shown in FIG. 16A, the reflective display panel further comprises a light source 020 which is arranged at one side of the second substrate away from the liquid crystal. The light source 020 can provide exciting light for the photoluminescence layer.

FIG. 16B is a schematic diagram of a reflective display panel according to an embodiment of the disclosure. As shown in FIG. 16B, the light source 020 may comprise a light guide plate 201 and a light-emitting device 202 arranged at the end part of the light guide plate. The light-emitting device 202 may be disposed at two sides of the light guide plate, or disposed at one side of the light guide plate.

Since the purity of light emitted from each region on the reflective display panel in the embodiment of the present disclosure is higher, the color gamut of the reflective display panel is larger, and the display effect is better.

From the above, since the first substrate in the reflective display panel provided by the embodiment of the disclosure comprises a reflective layer and a photoluminescence layer, the photoluminescence layer in the first substrate can emit excited light under the action of exciting light and the excited light has a small frequency range, the purity of light emitted from each region on the display panel is improved, and therefore the display effect of the display panel is improved.

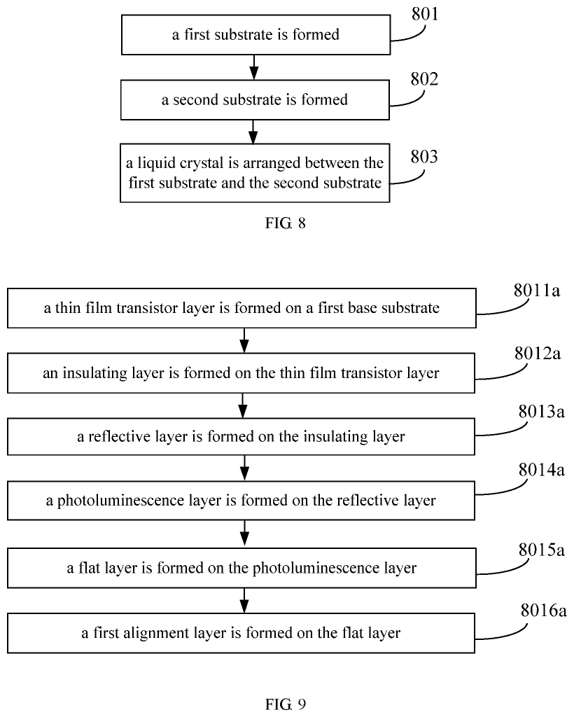

FIG. 8 is a flowchart of a method for manufacturing a reflective display panel provided by an embodiment of the disclosure. As shown in FIG. 8, the method for manufacturing a reflective display panel may comprise the following steps.

In Step 801, a first substrate is formed.

In Step 802, a second substrate is formed.

In Step 803, a liquid crystal is arranged between the first substrate and the second substrate.

It should be noted that the first substrate comprises a reflective layer and a photoluminescence layer, and the photoluminescence layer is arranged between the reflective layer and the liquid crystal. The photoluminescence layer can emit excited light under the action of exciting light. In one embodiment, the arrangement of the liquid crystal between the first substrate and the second substrate may be to arrange the liquid crystal on the first substrate, and then to arrange the first substrate and the second substrate opposite to each other. In one embodiment, the arrangement of the liquid crystal arranged between the first substrate and the second substrate may be to arrange the first substrate and the second substrate opposite to each other, and then to arrange the liquid crystal therebetween.

From the above, in the reflective display panel manufactured by the method of manufacturing the reflective display panel provided by the embodiment of the disclosure, since the first substrate comprises a reflective layer and a photoluminescence layer, the photoluminescence layer in the first substrate can emit excited light under the action of exciting light and the excited light has a smaller frequency range, the purity of light emitted from each region on the display panel is improved, and therefore the display effect of the display panel is improved.

The first substrate manufactured in Step 801 may be as shown in FIG. 5A or FIG. 6A.

As shown in FIG. 9, when the first substrate manufactured in Step 801 is as shown in FIG. 5A, Step 801 may comprise the following steps.

In Step 8011a, a thin film transistor layer is formed on a first base substrate.

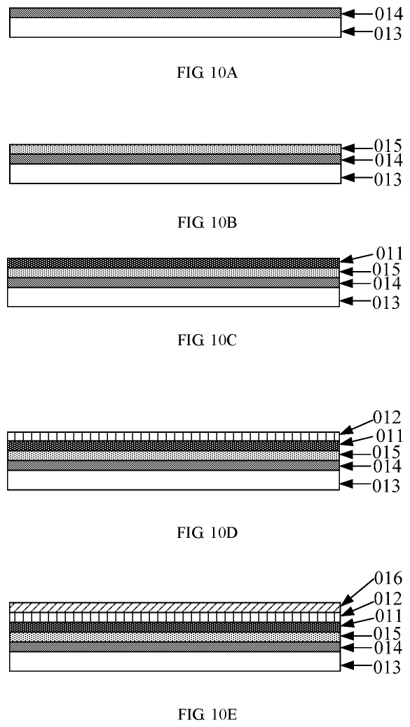

As shown in FIG. 10A, when the first substrate 01 as shown in FIG. 5A is manufactured, a thin film transistor layer 014 may be formed on the first base substrate first. Exemplarily, the thin film transistor layer 014 may comprise a plurality of thin film transistors 0141 which are arranged in an array, where each thin film transistor 0141 may comprise a gate electrode, a source electrode and a drain electrode.

That is, the thin film transistor layer 014 may comprise a plurality of film layers (such as a film layer where the gate electrode and a gate line are located, and a film layer where the source-drain electrode and a data line are located). Each time when a film layer is formed on the first base substrate, a corresponding material layer may be formed first, and then the material layer may be processed by adopting a single patterning process to obtain a film layer. The single patterning process may comprise: photoresist coating, exposure, development, etching and photoresist stripping. Therefore, processing the material layer by adopting the single patterning process comprises: coating a layer of photoresist on the material layer and performing exposure on the photoresist by adopting a mask plate, such that the photoresist forms a completely exposed region and a non-exposed region; next, processing the photoresist by adopting a developing process, such that the photoresist on the completely exposed region is removed, and the photoresist on the non-exposed region is reserved; then, etching the corresponding region of the completely exposed region on the material layer; stripping the photoresist on the non-exposed region after the etching is finished, thereby obtaining the corresponding film layer.

In Step 8012a, an insulating layer is formed on the thin film transistor layer.

As shown in FIG. 10B, after the thin film transistor layer 014 is formed on the first base substrate 013, an insulating layer 015 may be formed on the thin film transistor layer 014. Exemplarily, the insulating layer 015 may be formed on the thin film transistor layer 014 with the methods, such as coating, magnetron sputtering, thermal evaporation or Plasma Enhanced Chemical Vapor Deposition (PECVD).

Further, after the insulating layer 015 is formed, the insulating layer 015 may be processed by adopting the single patterning process, such that a plurality of via holes are formed in the insulating layer 015, and each via hole corresponds to a drain electrode in the thin film transistor structure.

In Step 8013a, a reflective layer is formed on the insulating layer.

As shown in FIG. 10C, a reflective layer 011 may be formed on the first base substrate 013 provided with the insulating layer 015 and the reflective layer 011 may be made of a conductor (such as, aluminum). The reflective layer 011 may comprise a plurality of reflective blocks (not shown in FIG. 10C) which are arranged in an array, and the plurality of reflective blocks are in a one-to-one connection with the drain electrodes in the plurality of thin film transistors through a plurality of via holes in the insulating layer 015, that is, the reflective layer 011 also plays a role of a pixel electrode at the same time. Therefore, no pixel electrode needs to be arranged in the first substrate additionally. Therefore, the thickness of the first substrate is reduced, and further the thickness of the reflective display panel is reduced. It should be noted that when the plurality of reflective blocks are formed, a reflective material layer may be formed first on the first base substrate in which the insulating layer is formed, and then the reflective material layer may be processed using the single patterning process to obtain the plurality of reflective blocks.

In Step 8014a, a photoluminescence layer is formed on the reflective layer.

Exemplarily, the photoluminescence layer in the embodiment of the disclosure may be a quantum dot layer. The quantum dot layer is configured to emit at least one color of excited light under the action of exciting light.

After the reflective layer 011 is formed, red quantum dot blocks may be formed on the reflective layer 011. In some embodiments, a red quantum dot material layer may be formed on the reflective layer 011 first, and then the red quantum dot material layer may be processed using the single patterning process to obtain the red quantum dot blocks. After the red quantum dot blocks are formed, green quantum dot blocks may be formed on the first base substrate 013 in which the red quantum dot blocks are formed. In some embodiments, a green quantum dot material layer may be first formed on the first base substrate 013 in which the red quantum dot blocks are formed, and then the green quantum dot material layer may be processed using the single patterning process to obtain the green quantum dot blocks. After the green quantum dot blocks are formed, transparent blocks may be formed on the first base substrate 013 in which the green quantum dot blocks are formed. In some embodiments, a transparent material layer may be first formed on the first base substrate 013 in which the green quantum dot blocks are formed, and then the transparent material layer may be processed using the single patterning process to obtain the transparent blocks. It should be noted that the red quantum dot blocks, the green quantum dot blocks and the transparent blocks can form the photoluminescence layer 012 as shown in FIG. 10D.

In Step 8015a, a flat layer is formed on the photoluminescence layer.

As shown in FIG. 10E, after the photoluminescence layer 012 is formed, a flat layer 016 may be formed on the photoluminescence layer 012.

It should be noted that in the embodiment of the disclosure, the transparent blocks formed in the Step 8014a and the flat layer formed in the Step 8015a may be made of the same material and may be formed at the same time.

In Step 8016a, a first alignment layer is formed on the flat layer.

As shown in FIG. 5A, after the flat layer 016 is formed, a first alignment layer 017 may be formed on the flat layer 016.

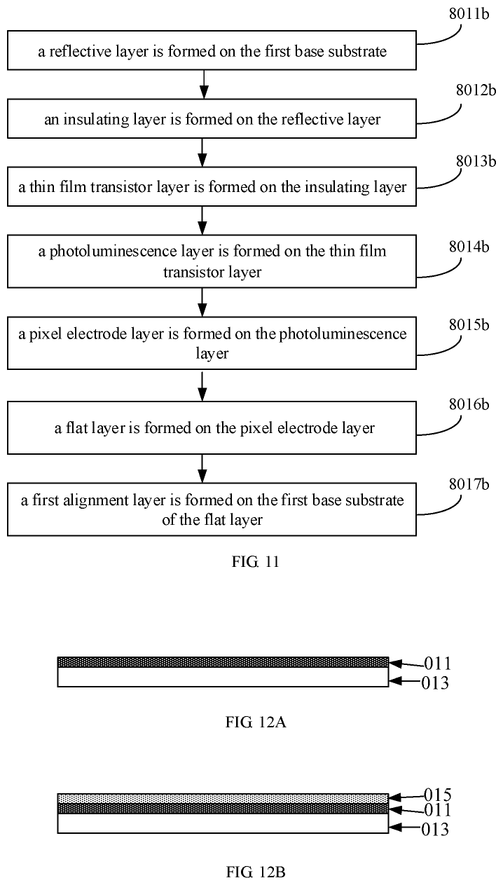

As shown FIG. 11, when the first substrate manufactured in the Step 801 is as shown in FIG. 6A, the Step 801 may comprise the following steps.

In Step 8011b, a reflective layer is formed on the first base substrate.

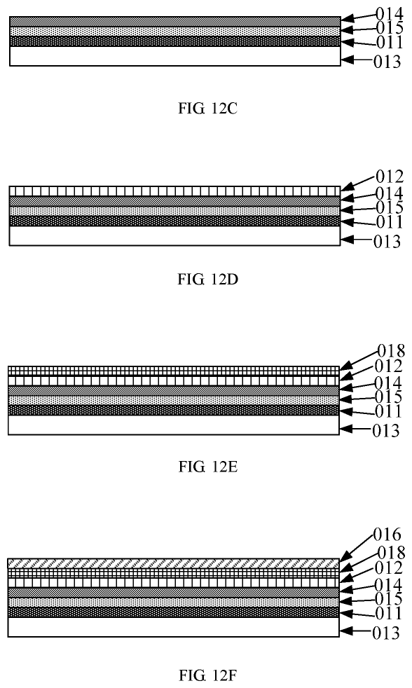

As shown in FIG. 12A, in the Step 8011b, the reflective layer 011 may be formed on the first base substrate 013 with the methods, such as coating, magnetron sputtering, thermal evaporation or PECVD. Exemplarily, the reflective layer 011 may be made of aluminum. In practice, the reflective layer may also be made of other materials, which will not be limited in the embodiment of the disclosure.

In Step 8012b, an insulating layer is formed on the reflective layer.

As shown in FIG. 12B, after the reflective layer 011 is formed, an insulating layer 015 may be formed on the reflective layer 011. The method for forming the insulating layer 015 may be the same as that for forming the reflective layer 011.

In Step 8013b, a thin film transistor layer is formed on the insulating layer.

As shown in FIG. 12C, after the insulating layer 015 is formed, a thin film transistor layer 014 may be formed on the insulating layer 015. Exemplarily, the specific step for forming the thin film transistor layer 014 in the Step 8013b may refer to the specific step for forming the thin film transistor layer in the Step 8011a, which will not be repeated again in the embodiment of the disclosure.

In Step 8014b, a photoluminescence layer is formed on the thin film transistor layer.

As shown in FIG. 12D, after the thin film transistor layer 014 is formed, a photoluminescence layer 012 may be formed on the thin film transistor layer 014, and the specific step for forming the photoluminescence layer 012 may refer to the specific step for forming the photoluminescence layer 012 in the Step 8014a, which will not be repeated in the embodiment of the disclosure.

Further, after the photoluminescence layer 012 is formed, the photoluminescence layer 012 may be processed by adopting the single patterning process, such that a plurality of via holes are formed in the photoluminescence layer 012, and each via hole corresponds to a drain electrode in the thin film transistor structure.

In Step 8015b, a pixel electrode is formed on the photoluminescence layer.

As shown in FIG. 12E, after the photoluminescence layer 012 is formed, a pixel electrode layer 018 may be formed on the photoluminescence layer 012. In addition, the specific step for forming the pixel electrode layer 018 may refer to the specific step for forming the reflective layer in the Step 8013a, which will not be repeated again in the embodiment of the disclosure.

It should be noted that the pixel electrode layer 018 may be connected with the drain electrodes in the thin film transistor layer 014 through via holes in the photoluminescence layer 012.

In Step 8016b, a flat layer is formed on the pixel electrode.

As shown in FIG. 12F, after the pixel electrode layer 018 is formed, a flat layer 016 may be formed on the pixel electrode layer 018.

In Step 8017b, a first alignment layer is formed on the first base substrate of the flat layer.

As shown in FIG. 6A, after the flat layer 016 is formed, a first alignment layer 017 may be formed on the flat layer 016.

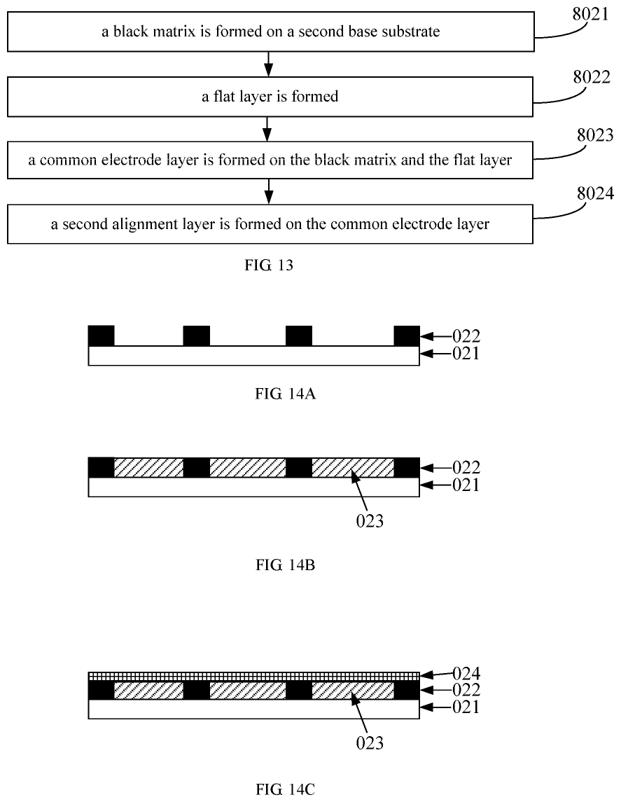

As shown in FIG. 13, the Step 802 may comprise the following steps.

In Step 8021, a black matrix is formed on a second base substrate.

As shown in FIG. 14A, in the course of executing the Step 8021, a black matrix 022 may be formed on a second base substrate 021. Exemplarily, a black matrix material layer may be formed first on the second base substrate 021, and then the black matrix material layer may be processed using the single patterning process to obtain a lattice-shaped black matrix 022.

When the first substrate and the second substrate are arranged opposite to each other, the black matrix can play a shielding effect on the thin film transistor structure on the first substrate, thereby further improving the display effect of the reflective display panel.

In Step 8022, a flat layer is formed on the second base substrate.

As shown in FIG. 14B, after the black matrix 022 is formed, a flat layer 023 may be formed on the second base substrate 021. It should be noted that the formed flat layer 023 and the black matrix 022 are disposed in the same layer.

In Step 8023, a common electrode layer is formed on the black matrix and the flat layer.

As shown in FIG. 14C, after the black matrix and the flat layer are formed, a common electrode layer 024 may be formed on the black matrix 022 and the flat layer 023 with the methods, such as coating, magnetron sputtering, thermal evaporation or PECVD. Exemplarily, the common electrode layer 024 may be made of indium tin oxide.

In Step 8024, a second alignment layer is formed on the common electrode layer.

As shown in FIG. 7, after the common electrode layer 024 is formed, a second alignment layer 025 may be formed on the common electrode layer 024.

It should be noted that when the second substrate is an array substrate, a reflective layer may be formed on the first base substrate first in the course of forming the first substrate in Step 801; then a photoluminescence layer may be formed on the reflective layer; a flat layer may be formed on the photoluminescence layer; a common electrode layer may be formed on the flat layer; and a first alignment layer may be formed on the common electrode layer.

In the course of forming the second substrate in Step 802, a black matrix and a flat layer may be formed at one side of the second base substrate towards the liquid crystal, the black matrix and the flat layer being disposed in the same layer; then a thin film transistor layer may be formed on the black matrix and the flat layer; next, an insulating layer may be arranged on the thin film transistor layer; a pixel electrode layer may be formed on the insulating layer, the pixel electrode layer being connecting to the drain electrodes in the thin film transistor layer through via holes in the insulating layer; and a second alignment layer may be formed on the pixel electrode layer.

It should be noted that the thin film transistor layer may be made of a transparent material when the second base substrate is an array substrate.

Further, in the text embodiment of the present disclosure, a first polarizer and a second polarizer may be arranged in sequence at one side of the photoluminescence layer towards the second substrate in a direction away from the photoluminescence layer.

On the one hand, the liquid crystal arranged between the first substrate and the second substrate in the Step 804 may be a guest-host liquid crystal. Then, after the Step 804, the method for manufacturing the reflective display panel may further comprise: arranging a polaroid at one side of the second substrate away from the first substrate. That is, the first polarizer in the reflective display panel may comprise a guest-host liquid crystal, and the second polarizer may comprise a polaroid.

On the one hand, the liquid crystal arranged between the first substrate and the second substrate in the Step 804 may not be a guest-host liquid crystal. Then, after the Step 803, it a first polaroid needs to be arranged at one side of the first substrate towards the second substrate. After the Step 804, the first polaroid is disposed between the liquid crystal and the first substrate. Further, after the Step 804, a second polaroid needs to be arranged at one side of the second substrate away from the first substrate, and the light transmission axis of the first polaroid needs to be vertical to the light transmission axis of the second polaroid.

From the above, in the reflective display panel manufactured by the method for manufacturing the reflective display panel provided by the embodiment of the disclosure, since the first substrate comprises a reflective layer and a photoluminescence layer, the photoluminescence layer in the first substrate can emit the excited light and the excited light has a smaller frequency range, the purity of light emitted from each region on the display panel is improved, and therefore the display effect of the display panel is improved.

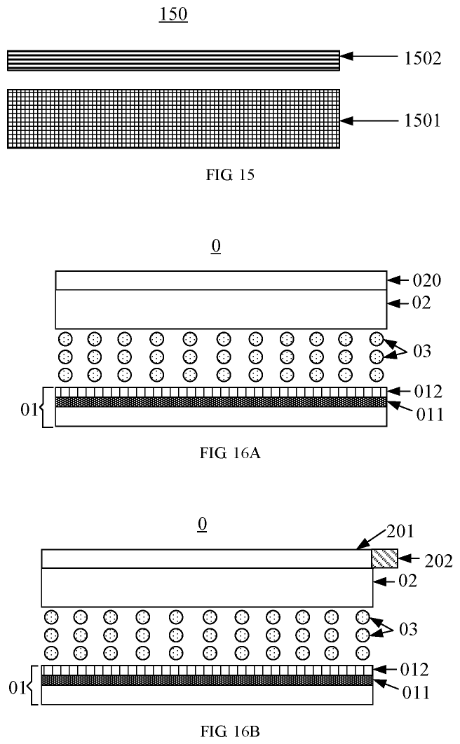

As shown in FIG. 15, an embodiment of the disclosure provides a display device 150. The display device 150 may comprise a reflective display panel 1501 which may be as shown in any of FIGS. 2 to 4.

In some embodiments, the display device 150 may further comprise: a light source 1502 which is configured to emit exciting light to the display panel 0.

From the above, in the reflective display panel in the display device provided by the embodiment of the disclosure, since the first substrate comprises a reflective layer and a photoluminescence layer, the photoluminescence layer in the first substrate can emit excited light under the action of exciting light and the excited light has a smaller frequency range, the purity of light emitted from each region on the display panel is improved, and therefore the display effect of the display panel is improved.

It should be noted that the embodiment of the reflective display panel, the embodiment of the method for manufacturing the reflective display panel and the embodiment of the display device, which are provided by the present disclosure, may be referenced to each other, and will not be limited in the embodiment of the present disclosure.

The display device may be a display panel, a display, a TV, a tablet computer, a mobile phone, a navigator and other devices having a display function and will not be limited in the present disclosure.

The foregoing are only preferred embodiments of the present disclosure, and are not intended to limit the present disclosure. Within the spirit and principles of the disclosure, any modifications, equivalent substitutions, improvements, etc., are within the scope of protection of the present disclosure.

1. A reflective display panel, comprising:
a first substrate and a second substrate which are arranged opposite to each other; and
a liquid crystal arranged between the first substrate and the second substrate, wherein the first substrate comprises a reflective layer and a photoluminescence layer, and the photoluminescence layer is arranged between the reflective layer and the liquid crystal.

2. The reflective display panel according to claim 1, wherein the photoluminescence layer comprises a quantum dot layer which is configured to emit at least one color of excited light under the action of exciting light.

3. The reflective display panel according to claim 2, wherein the quantum dot layer comprises: red quantum dot blocks, green quantum dot blocks and transparent blocks;
the red quantum dot blocks are configured to emit red excited light under the action of blue exciting light, and the green quantum dot blocks are configured to emit green excited light under the action of blue exciting light.

4. The reflective display panel according to claim 1, wherein
a first polarizer and a second polarizer are arranged at one side of the photoluminescence layer towards the second substrate in sequence in a direction away from the photoluminescence layer.

5. The reflective display panel according to claim 1, wherein
the liquid crystal is a guest-host liquid crystal, a second polarizer is arranged at one side of the liquid crystal in a direction away from the photoluminescence layer.

6. (canceled)

7. (canceled)

8. (canceled)

9. The reflective display panel according to claim 1, wherein
the first substrate further comprises a first base substrate;
a thin film transistor layer arranged on the first base substrate and comprising a plurality of thin film transistors which are arranged in an array;
an insulating layer arranged on the thin film transistor layer, wherein the reflective layer is arranged on the insulating layer, the photoluminescence layer is arranged on the reflective layer, the reflective layer is made of a conductor and comprises a plurality of reflective blocks which are arranged in an array, and the plurality of reflective blocks are in a one-to-one connection with drain electrodes in the plurality of thin film transistors through via holes in the insulating layer;
a flat layer arranged on the photoluminescence layer; and
a first alignment layer arranged on the flat layer.

10. The reflective display panel according to claim 1, wherein
the first substrate further comprises a first base substrate, wherein the reflective layer is arranged on the first base substrate; an insulating layer arranged on the reflective layer;
a thin film transistor layer arranged on the insulating layer, wherein the photoluminescence layer is arranged on the thin film transistor layer, wherein the thin film transistor layer comprises a plurality of thin film transistors;
a pixel electrode layer arranged on the photoluminescence layer, wherein the pixel electrode layer comprises a plurality of pixel electrodes, and the plurality of pixel electrodes are in a one-to-one connection with the plurality of thin film transistors through via holes in the photoluminescence layer;
a flat layer arranged on the pixel electrode layer; and
a first alignment layer arranged on the flat layer.

11. The reflective display panel according to claim 1, wherein the second substrate comprises:
a second base substrate; a black matrix and a flat layer arranged at one side of the second base substrate towards the liquid crystal and disposed in the same layer;
a common electrode layer arranged at one side of the black matrix and the flat layer towards the liquid crystal; and
a second alignment layer arranged at one side of the common electrode layer towards the liquid crystal.

12. The reflective display panel according to claim 1, further comprising a light source which is arranged at one side of the second substrate away from the liquid crystal and configured to generate exciting light that excites the photoluminescence layer.

13. The reflective display panel according to claim 12, wherein the light source comprises a light guide plate and a light-emitting device arranged at an end of the light guide plate.

14. A method for manufacturing a reflective display panel, comprising:
forming a first substrate;
forming a second substrate; and
arranging a liquid crystal between the first substrate and the second substrate, wherein
the first substrate comprises a reflective layer and a photoluminescence layer, and the photoluminescence layer is arranged between the reflective layer and the liquid crystal.

15. The method according to claim 14, wherein
the photoluminescence layer comprises a quantum dot layer which is configured to emit at least one color of excited light under the action of exciting light.

16. The method according to claim 15, wherein the quantum dot layer comprises red quantum dot blocks, green quantum dot blocks and transparent blocks, wherein
the red quantum dot blocks are configured to emit red excited light under the action of blue exciting light, and the green quantum dot blocks are configured to emit green excited light under the action of blue exciting light.

17. The method according to claim 14, wherein after arranging the liquid crystal between the first substrate and the second substrate, the method further comprises:
arranging a first polarizer and a second polarizer at one side of the photoluminescence layer towards the second substrate in sequence in a direction away from the photoluminescence layer.

18. The method according to claim 14, wherein
the liquid crystal is a guest-host liquid crystal and after arranging the liquid crystal between the first substrate and the second substrate, the method further comprises:
arranging a second polarizer at one side of the liquid crystal in a direction away from the photoluminescence layer.

19. A display device, comprising a reflective display panel, wherein the reflective display panel includes:
a first substrate and a second substrate which are arranged opposite to each other; and
a liquid crystal arranged between the first substrate and the second substrate,
wherein the first substrate comprises a reflective layer and a photoluminescence layer, and the photoluminescence layer is arranged between the reflective layer and the liquid crystal.

20. The display device according to claim 19, further comprising a light source which is configured to emit exciting light for exciting the photoluminescence layer to the second substrate of the display panel.

21. The method according to claim 14, wherein forming the first substrate includes:
forming a thin film transistor layer on a first base substrate, wherein the thin film transistor layer comprises a plurality of thin film transistors;
forming an insulating layer on the thin film transistor layer , wherein the thin film transistor layer comprises a plurality of thin film transistors;
forming the reflective layer on the insulating layer, wherein the reflective layer is a conductor and comprises a plurality of reflective blocks, and the plurality of reflective blocks are in a one-to-one connection with drain electrodes in the plurality of thin film transistors through via holes in the insulating layer;
forming the photoluminescence layer on the reflective layer;
forming a flat layer on the photoluminescence layer; and
forming a first alignment layer on the flat layer.

22. The method according to claim 14, wherein forming the first substrate includes:
forming the reflective layer on a first base substrate;
forming an insulating layer on the reflective layer;
forming a thin film transistor layer on the insulating layer, wherein the thin film transistor layer comprises a plurality of thin film transistors;
forming the photoluminescence layer on the thin film transistor layer;
forming a pixel electrode layer on the photoluminescence layer, wherein the pixel electrode layer comprises a plurality of pixel electrodes and the plurality of pixel electrodes are in a one-to-one connection with drain electrodes in the plurality of thin film transistors through via holes in the photoluminescence layer;
forming a flat layer on the pixel electrode layer; and
forming a first alignment layer on the flat layer.

23. The method according to claim 14, wherein forming the second substrate includes:
forming a black matrix and a flat layer on a second base substrate, wherein the black matrix and the flat layer are disposed in the same layer;
forming a common electrode layer on the black matrix and the flat layer; and
forming a second alignment layer on the common electrode layer.
